(19) United States
(12) Patent Application Publication
(10) Pub. No.: US 2026/0338628 A1
(43) Pub. Date: Oct. 29, 2026

(54) METHOD FOR DETECTING LEAKAGE OF VALVE UPSTREAM OF T-JUNCTION

(71) Applicant: NIHON KOSO CO., LTD., Chuo-ku, Tokyo (JP)

(72) Inventor: Sanjay SHERIKAR, Mission Viejo, CA (US)

(21) Appl. No.: 19/189,863

(22) Filed: Apr. 25, 2025

(51) Int. Cl. G01M 3/00; F01D 21/00

(52) U.S. Cl. CPC G01M 3/002; F01D 21/003

(57) ABSTRACT

A method for determining leakage past a high-pressure bypass steam valve flowing to a cold reheat line, includes measuring a temperature difference (ΔT) between cold reheat steam and steam in a mixing zone at a T-junction where a high-pressure bypass outlet pipe downstream of the high-pressure bypass steam valve is joined to the cold reheat line.

### BACKGROUND OF THE INVENTION

### Field of the Invention

The present invention generally relates to a method for detecting leakage of a valve upstream of a T-junction such as a high-pressure bypass steam control valve used in a stem power station.

### Description of Related Art

In power generating systems such as steam power stations, high-pressure steam flowing into a turbine is controlled by a bypass valve. The bypass valve plays a major role in the operating efficiency of power generation systems. When the turbine is fully operated with high-pressure steam, the bypass valve is closed. However, the bypass valve performance degrades over time because of degradation of the valve sealing surfaces, resulting in a loss of power plant efficiency as well as creating a potential for damage to downstream components. Erosion may also occur as a result of fluid flowing past the valve seat of the bypass valve when in an open position. Excessive valve leakage may require the temporary isolation of the portion of the fluid circuit containing the leaking bypass valve so that the bypass valve may be serviced. In extreme cases, excess valve leakage may necessitate that the power generating system be taken offline in order to replace the leaking bypass valve. Excessive leakage may also have a significant economic impact on the operating costs of the power generating system. Thus, it is important to not only detect leakage of the valve but also quantify the valve leakage in advance.

The present inventor developed technology of monitoring valves and quantifying valve leakage as disclosed in U.S. Pat. No. 7,031,851, in which leakage of a valve is detected based on enthalpy changes determined by measuring the temperature at a first end of a pipe and the temperature at a second end of the pipe. However, the above method has a problem in that the range of the leakage flows which can be estimated with the method is very small. In practice, much higher leakage flows are often encountered for which the estimation method described in the patent is ineffective.

Some embodiments of the new method disclosed herein are based on the characteristics of local mixing in a recirculation region (a mixing zone) at a T-junction, and uses a different principle as described in the current disclosure, allowing estimation of a much wider range of leakages and with much better accuracy than the method disclosed in the above-discussed patent.

Any discussion of problems and solutions in relation to the related art has been included in this disclosure solely for the purposes of providing a context for the present invention, and should not be taken as an admission that any or all of the discussion was known at the time the invention was made.

### SUMMARY OF THE INVENTION

Some embodiments provide a method for detecting leakage of a valve upstream of a T-junction where an auxiliary line, which fluidly connects the valve and the T-junction, is fluidly connected to a primary line, the method comprising steps of:
passing fluid through the primary line as a primary fluid flow;
measuring a temperature (T1) and a flow rate (W1) of the primary fluid flow upstream of the T-junction;
measuring a temperature (T2) of fluid, if any, passing through the auxiliary line as a leakage flow toward the T-junction;
identifying a mixing zone formed in the auxiliary line at and upstream of the T-junction, where both the fluid of the primary fluid flow and the fluid of the auxiliary fluid flow are present due to fluid dynamics at the T-junction depending on a flow ratio of a flow rate (W2) of the leakage flow to W1;
measuring a temperature (Tx) of fluid present in the mixing zone, where T1<Tx<T2, and when W2=0, Tx=T1; and
determining W2 from a temperature difference (ΔT) between Tx and T1 based on a predetermined relationship between W2 and ΔT in relation to W1.

In some embodiments, the valve is a high-pressure bypass steam control valve (also referred to as “steam bypass valve”), the auxiliary line is a high-pressure bypass outlet line (also referred to as “HP bypass outlet”), the primary line is a cold reheat line downstream of a high-pressure steam turbine, the fluid passing through the primary line is cold reheat steam passing through the cold reheat line, and the fluid passing through the auxiliary line is fluid passing through the high-pressure bypass outlet line.

Further, in some embodiments, Tx is measured in the mixing zone at a location away from the T-junction by about a distance (Dx) which corresponds to an inner diameter of a pipe of the auxiliary line.

Additionally, in some embodiments, the predetermined relationship between W2 and ΔT in relation to W1 is a function of W2 and ΔT (e.g., approximately a linear function).

Accordingly, in some embodiments of the new method, by using the temperature (Tx) of fluid present in the mixing zone at the T-junction, valve leakage can be quantitively estimated in a wide range of leakages with high accuracy.

For purposes of summarizing aspects of the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description which follows.

### BRIEF DESCRIPTION OF THE DRAWINGS

These and other features of this invention will now be described with reference to the drawings of preferred embodiments which are intended to illustrate and not to limit the invention. The drawings are greatly simplified for illustrative purposes and are not necessarily to scale. Also, the patent or application file contains at least one drawing executed in color. Copies of this patent or patent application publication with color drawing(s) will be provided by the Office upon request and payment of the necessary fee.

FIG. 1 is a schematic diagram of a steam turbine system for a type of steam power station to which an embodiment of the present invention applies.

FIG. 2 is a schematic view of a piping configuration including a T-junction according to an embodiment of the present invention.

FIG. 3 shows Computational Fluid Dynamic (CFD) analysis results (in color) for a case of a leaking steam bypass valve, wherein the top left image shows the results of velocity analysis along an HP bypass outlet line connected to a T-junction, the top right image shows the results of velocity analysis in a mixing zone at the T-junction, the bottom left image shows the results of temperature analysis along an HP bypass outlet line connected to the T-junction, the bottom right image shows the results of temperature analysis in the mixing zone at the T-junction.

FIG. 4 is a partial view of the steam power station illustrated in FIG. 1, showing locations of temperature sensors according to an embodiment of the present invention.

FIG. 5 indicates a location of temperature sensor in the mixing zone in the bottom right image of FIG. 3 according to an embodiment of the present invention.

FIG. 6 shows a plot of leakage flow rate versus temperature difference (derived from CFD analysis) at 0.5 m upstream of the T-junction where the HP bypass flow merges with the cold reheat line as shown in FIG. 3, according to an embodiment of the present invention.

FIG. 7 shows an example to determine a leakage rate based on a difference between the temperature of fluid present in the mixing zone and the temperature of the cold reheat line according to an embodiment of the present invention.

### DETAILED DESCRIPTION OF EMBODIMENTS

In this disclosure, “fluid” may include a single-phase fluid where the fluid is liquid or gas or steam, and a two-phase fluid where the fluid is a mixture of liquid and gas or steam. Also, in this disclosure, “high pressure” may refer to pressure upstream of a high-pressure turbine in, e.g., steam power stations or other power-generating systems. When “high pressure” is used as an adjective, such as high-pressure spray water, it may not refer to pressure but may refer to “high-pressure side” which is a side upstream of a high-pressure turbine. Although “high” is a relative term, a skilled artisan in the art would readily understand what the term refers to in the context as a technical term commonly used in this industry. In the same manner, the skilled artisan would readily understand what “low pressure” or “intermediate pressure” refers to in the context. Additionally, in this disclosure, an article “a” or “an” refers to a species or a genus including multiple species, depending on the context. Further, in this disclosure, any two numbers of a variable can constitute a workable range of the variable as the workable range can be determined based on routine work, and any ranges indicated may include or exclude the endpoints. Also, any values of variables indicated (regardless of whether they are indicated with “about” or not) may refer to precise values or approximate/rounded values and include equivalents, and may refer to average, median, representative, majority, etc. in some embodiments.

In the present disclosure where conditions and/or structures are not specified, the skilled artisan in the art can readily provide such conditions and/or structures, in view of the present disclosure, as a matter of routine experimentation.

The embodiments will be explained with respect to preferred embodiments. However, the present invention is not limited to the preferred embodiments.

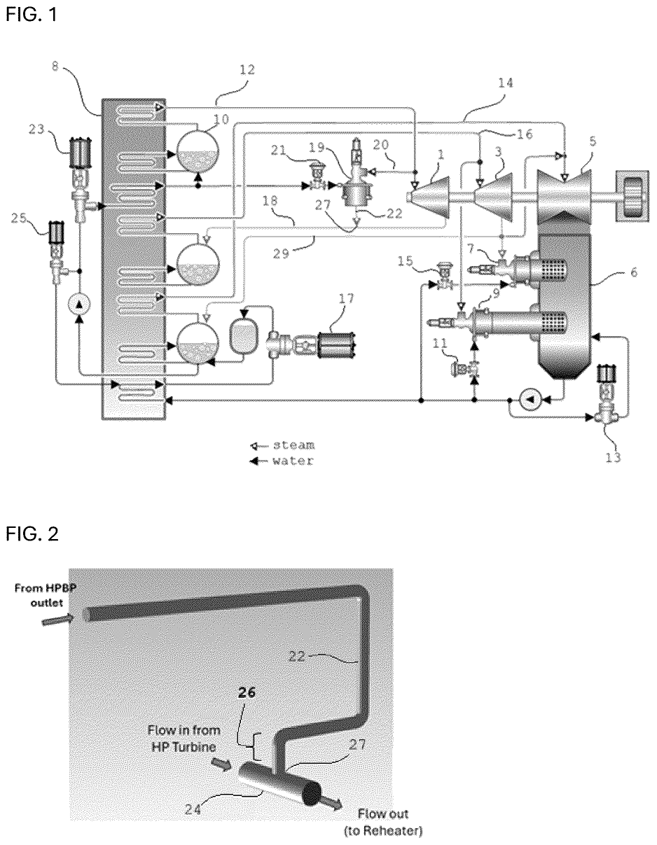

FIG. 1 is a schematic diagram of the steam power station to which an embodiment of the present invention applies. This steam power station comprises three turbines, a high-pressure (HP) steam turbine 1, an intermediate pressure (IP) steam turbine 3, and a low pressure (LP) steam turbine 5, wherein steam is introduced to each turbine from respective drums 10 (boiler reheater) through an HP steam line 12 via a heat exchanger 8, an IP steam line 16, and a LP steam line 14, respectively. The amount of water supplied to each drum 10 is regulated by a feed water regulator 23, a BFP recirculation regulator 25, and a deaerator level controller 17. Steam (turbine exhaust), which is discharged from the HP steam turbine 1 and the IP steam turbine 3, is fed back to the respective drum 10 through a cold reheat line 18 and a cold reheat line 29, respectively, and steam (turbine exhaust), which is discharged from the LP steam turbine 5, is fed to a condenser 6 from where the working fluid (water) is recycled into the process cycle via a condensate booster pump 13. It should be noted, however, that only a small part of the flow from the IP steam turbine 3 goes to the IP drum while the rest goes directly to the LP steam turbine 5. An HP bypass steam control valve 19 (also referred to as a “HP bypass valve”), an IP bypass steam control valve 7 (also referred to as an “IP bypass valve”), and an LP bypass steam control valve 9 (also referred to as a “LP bypass valve”) are required to bypass (or divert) the steam flow from the HP steam turbine 1, the IP steam turbine 3, and the LP steam turbine 5, respectively, when these steam turbines are not ready for intake of steam being produced in the drums 10; such requirements are exercised during a power station startup or shutdown, or during emergencies. An HP spray water valve 21, an IP spray water valve 11, and an LP spray water valve 15 supply water for cooling the steam which has been bypassed through the HP bypass valve 18, the IP bypass valve 29, and the LP bypass valve 9, respectively.

In the above station, ensuring that the HP turbine 1 receives the intended flow rate is important for power-generating efficiency. When the HP turbine is fully operational, the HP bypass valve 19 is closed. However, as discussed earlier, the HP bypass valve 19 deteriorates over time, and results in leakage, which results in a significant loss of efficiency and increase of operational costs.

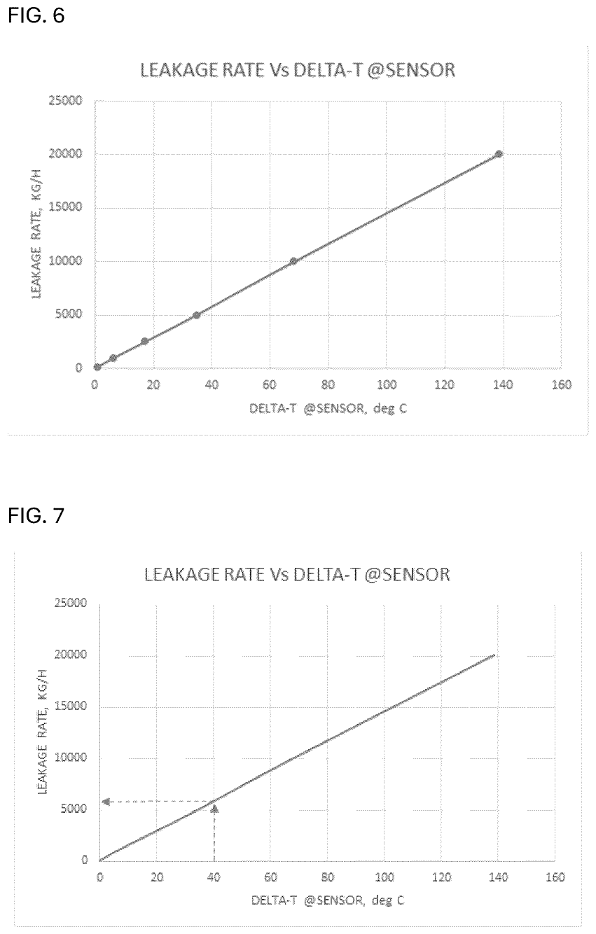

However, conventional methods such as those disclosed in U.S. Pat. No. 7,031,851 discussed earlier, which measure temperature at two points of the same pipe, cannot accurately quantify the valve leakage when flow passing through the pipe becomes as high as a realistic/practical level. That is, the principle described above is basically the energy balance equation considering the reduction in the energy content of leakage flow and heat loss to the ambient region from the surface of the pipe carrying the leakage flow. The accuracy of leakage flow estimate is limited by the practical limits of accuracy of temperature measurements. For example, in the conventional method, the smallest temperature difference (between temperatures downstream and upstream of the T-junction) which can reliably be measured in practice is 2 °C, wherein the smallest HP bypass leakage flow that may be estimated is about 17,500 kg/h. In contrast, with the method disclosed in this disclosure, a 2 °C temperature difference (ΔT) would correspond to about 300 kg/h as shown in FIG. 6 discussed later. This means that the conventional method is not reliable in even detecting leakage below about 10,000 kg/h, whereas the disclosed method can detect leakage flow of as small as 300 kg/h. This illustrates the vastly superior accuracy and sensitivity of the disclosed method as compared with the conventional method.

Returning to FIG. 1, steam flows into the HP bypass valve 19 through an HP bypass inlet line 20 which is a branch off of the HP steam line 12, and leaked steam flows out from the HP bypass valve 19 through an HP bypass outlet line 22 which is fluidly connected to the cold reheat line 18 via a T-junction 27.

FIG. 2 is a schematic view of a naked piping configuration (insulation material is omitted for illustrative purposes) including a T-junction according to an embodiment of the present invention. Steam discharged from the HP bypass valve flows through the HP bypass outlet line 22 (as an auxiliary line) and flows into, via the T-junction 27, steam flowing through a cold reheat header 24 provided in the cold reheat line 18 (as a primary line). During normal plant operation, no steam flow is expected or desired in the HP bypass outlet pipe since the bypass valve is closed. However, if any steam leaks from the valve, then it is of interest for the power station to know the leaking steam flow rate. The leaking steam flows into the piping downstream of the valve and merges with cold reheat steam (from the HP turbine as an exhaust, flowing to the boiler reheater). A downstream temperature sensor (provided downstream of the valve) which is used to control spray water flow can give indication of steam leak from the valve, but it is generally not practical (due to many complications) to quantify the leakage flow from its indication. On the other hand, a temperature measurement in a mixing zone 26, where the leakage flow and the cold reheat flow meet, enables accurate estimation of leakage flow rate as described in this disclosure.

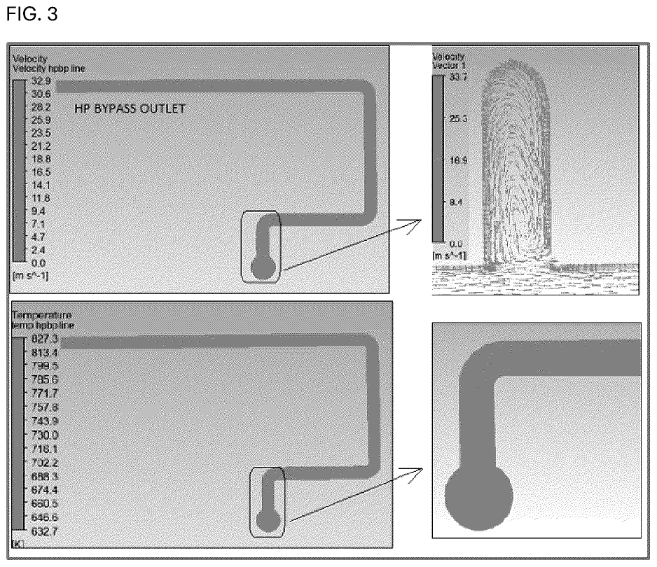

FIG. 3 shows Computational Fluid Dynamic (CFD) analysis results (in color) for a case of a leaking steam bypass valve, wherein the top left image shows the results of velocity analysis along an HP bypass outlet line connected to a T-junction, the top right image shows the results of velocity analysis in a mixing zone at the T-junction, the bottom left image shows the results of temperature analysis along an HP bypass outlet line connected to the T-junction, the bottom right image shows the results of temperature analysis in the mixing zone at the T-junction.

It is confirmed that, as indicated in the bottom images of FIG. 3, the steam temperature Tx in the mixing zone is seen to be between temperature T1 of the cold reheat flow and temperature T2 of the bypass outlet flow. In addition, its magnitude of temperature difference (ΔT=Tx−T1) is found to depend primarily on the ratio (W1/W2) and the location in the mixing zone for a given system (W1 is a flow rate of the cold reheat flow, W2 is a flow rate of the bypass outlet flow).

An analysis for different steam leakage rates shows a relationship which is illustrated in FIG. 6 which shows CFD results for W2=1,690,530 kg/h at 54 barA/360 °C, W1=10,000 kg/h at 554 °C wherein indicated is a plot of leakage flow rate versus temperature difference at 0.5 m upstream of the T-junction as shown in FIG. 3. The drawn line represents the expected system characteristics. FIG. 6 shows that steam leakage is a function of ΔT (ΔT is the temperature difference between Tx and T1). Since W2, T1, and T2 are known from the plant instrumentation, the leakage flow from the HP bypass steam valve (W1) can be determined directly from measurement of temperature Tx. For example, FIG. 7 shows an example to determine a leakage rate based on ΔT according to an embodiment of the present invention. FIG. 7 illustrates the application of this principle for a specific case, wherein ΔT of 40 °C between T1 and T2 (measured at 0.5 m upstream of the T-junction where the HP bypass flow merges with the cold reheat line) corresponds to HP bypass valve leakage of approximately 5,800 kg/h as indicated by the arrow path, and thus, if ΔT is 40 °C, valve leakage (W1) can be estimated as 5,800 kg/h when W2 is 1,690,530 kg/h.

The flow in the mixing zone is complicated as indicated in the top images o FIG. 3. However, the relationship between the leakage rate and the temperature difference can surprisingly be expressed as a linear function as indicated in FIG. 6. This phenomenon can be explained in scientific terms. At the interface between the HP bypass outlet flow and the cold reheat flow in the geometry described here, there is a natural tendency for some of the cold reheat flow at the interface to enter the HP bypass outlet line in the absence of flow, or minimal flow, from the steam bypass valve. The amount of cold reheat flow that enters the HP bypass outlet line depends on the resistance which cold reheat flow faces from leakage flow in the HP bypass outlet pipe. The maximum amount of cold reheat flow enters the HP bypass outlet line when there is no flow, or zero leakage, from the HP bypass valve. In this condition, the temperature Tx is the same as T2. When there is leakage flow, it eventually merges and mixes with the cold reheat flow. If the leakage is small, the mixing happens in the HP bypass outlet pipe before the T-junction; if the leakage is large, the mixing happens in the cold reheat pipe after the T-junction. An increasing amount of leakage from the HP bypass valve results in a corresponding reduction in the amount of cold reheat flow that enters the HP bypass outlet line; likewise, the temperature Tx of mixed flow increases towards a temperature downstream of the T-junction, wherein the actual value changes depending on the proportion of leakage flow in the mixture at the location of the sensor for Tx. At some point, the leakage from the HP bypass valve is large enough that it has sufficient momentum to prevent the cold reheat flow from reaching the sensor location in the HP bypass line for Tx. This becomes the upper limit for estimation of leakage flow with this method. In such cases, the leakage flow mixes with the cold reheat flow only after the T-junction.

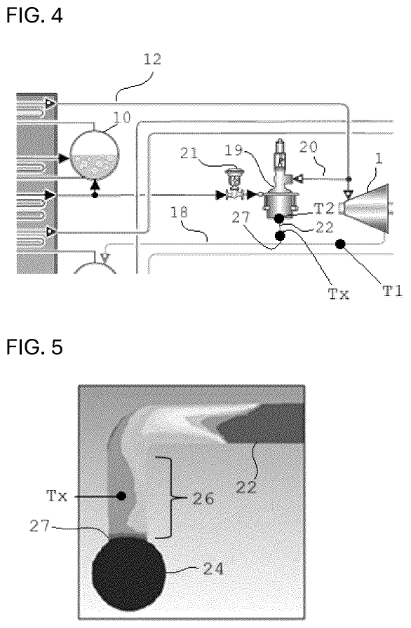

The locations where the measuring gauges (sensors) for T1, T2, and Tx are provided are shown in FIGS. 4 and 5. FIG. 4 is a partial view of the steam power station illustrated in FIG. 1, showing locations of temperature sensors according to an embodiment of the present invention. FIG. 5 indicates the location of temperature sensor in the mixing zone in the lower right image of FIG. 3 according to an embodiment of the present invention. Value of W2 is taken from the steam plant's control system. Leakage flow W1 is determined from a graph such as FIG. 6.

In practice, the location for measurement of temperature Tx needs to be selected optimally. It affects the accuracy and range of leakage flow (W1) estimate. A location of Tx measurement away from the T-junction improves the accuracy for low values W1. Conversely, a location of Tx measurement closer to the T-junction increases the maximum value of W1 that can be estimated. For example, an optimum location for measuring Tx is approximately one-pipe diameter upstream of the T-junction (or at a distance from the T-junction equivalent to about 0.5 to 1.5 times the pipe diameter; if the diameter of the bypass outlet line is, for example, 0.5 m, the location may be 0.25 m to 0.75 m upstream of the T-junction), wherein the “pipe diameter” refers to a diameter of the bypass outlet line. Depending on the user's intent, the actual location for measuring Tx can be a little further upstream of the optimum location or a little further downstream of the optimum location. Locations further upstream increase sensitivity to small leakage flow rates whereas locations little closer to the T-junction increase the upper limit of leakage flow that can be measured.

In order to estimate W1 based on ΔT, a calibration curve (like FIG. 6) for the system of interest has to be available in advance. Such a calibration curve may be available from previously established graphs for the relationship between the leakage flow and temperature difference for different combinations of sizes of the T-junction. For a new system, CFD analysis can be used to establish a calibration curve (CFD is an analytical tool that is readily available to practitioners in this field). Leakage rate data points such as those shown in FIG. 6 can be determined based on CFD using software. The commonly used software and the companies which offer it are as follows. A curve is then fitted for these points.
ANSYS, CFX, FLUENT (from ANSYS Inc)
OpenFOAM (open source, freeware)
COMSOL Multiphysics (from COMSOL Inc)
Simscale (from Simscale)
ConvergeCFD (from Convergent Science)
FLOW-3D (from Flow Science)
PHOENICS (CHAM, U.K.)
Simcenter STAR-CCM+ (from Siemens)
Autodesk CFD (from Autodesk CFD)
FUN3D, OVERFLOW, and Cart3D (from NASA)
Abaqus CFD (from Dassault Systèmes Simulia Corp.)

The leakage detection method disclosed in this disclosure can apply to all steam systems in which the outlet of steam bypass valves connects to another steam flow which is at a substantially cooler temperature. A graph of the relationship between the leakage flow and temperature difference for different combinations of sizes of the T-junction can be established in advance since it is an easy tool for those skilled in the art to readily practice this leakage detection method in their systems. Alternatively, CFD analysis can be used to establish graphs of the relationship between the leakage flow and temperature difference.

### Additional Discussions

### Application

The method disclosed in this disclosure can effectively be used to estimate leakage from HP bypass steam valves. It is easy and requires only one temperature measurement at an optimal location on an outer surface of the steam pipe, which makes it non-intrusive; other parameters can generally be available or obtained from the existing plant instrumentation. Estimation of steam leakage allows cost-benefit analysis for countermeasures under consideration. In the event of high leakage, it becomes possible to notify plant operators that the payback period for replacement of the poorly performing valve can be very imminent, perhaps, in a period as short as few months. The approach described here can be extended to other applications which are similar in configuration, and with a similar requirement (to estimate branch leakage flow). If there is a requirement for an on-site installation, it is possible to make a “Leakage Meter” for an HP bypass steam valve with the technique described in this disclosure.

Further, this method lends itself to easy use in any online Heat Rate monitoring program. Accuracy of heat rate is very important for plant operators. Including losses due to HP bypass leakage, overall plant performance monitoring studies will improve the accuracy of heat rate estimates of steam power stations. This method can be made available to companies which are in the business of doing such plant performance monitoring studies.

### Computational Fluid Dynamics

Computational Fluid Dynamics (CFD) is a field of study that uses computers to simulate and analyze how fluids, like air or water, move and interact with objects. By creating detailed virtual models, CFD allows engineers and scientists to predict how these fluids will behave under different conditions, without needing to physically test them. This is helpful in designing things like airplanes, automobiles, and even medical devices. CFD can show how fluids flow around surfaces or inside piping systems, how heat transfers, and how forces affect objects in the fluid, helping to improve efficiency, safety, and performance in many industries. When it is done properly, CFD can provide highly accurate insights that help in designing products, solving problems and making discoveries. The science of CFD has advanced rapidly in conjunction with the advances in computing; it has become an indispensable and valuable tool for research and for sophisticated engineering design work.

### General Description of Steam Power Plant Operation

A steam power plant generates electricity by converting heat energy into mechanical energy using steam. The basic process begins in a boiler, where water is heated by burning fuel (such as coal, natural gas, or oil). The heat causes water to turn into steam at high pressure. This steam is then directed into a turbine, a large rotating machine. As the steam in the turbine expands and passes through the turbine blades, it causes the turbine to spin, converting thermal energy of the steam into mechanical energy. The turbine is connected to a generator, so that as the turbine spins, it also turns the generator, producing electricity. After passing through the turbine, the exhaust steam is cooled down in a condenser, where it turns back into water. This cooled water is then pumped back into the boiler to be reheated, and the cycle repeats.

### Process in a Steam Power Plant

Description of the process flow in a steam power plant:
1. Boiler: Water is heated in the boiler by burning fuel (coal, natural gas, etc.), turning it into high-pressure steam.
2. Turbine: The high-pressure steam flows to the turbine, where it causes the turbine blades to spin, converting thermal energy into mechanical energy.
3. Generator: The turbine is connected to a generator, which converts the mechanical energy into electrical energy.
4. Condenser: After passing through the turbine, the exhaust steam enters the condenser, where it is cooled and turns back into water.
5. Feed Water Pump: The condensed water is pumped back into the boiler to be reheated, completing the cycle.
6. Cooling Tower: In some plants, the condenser water is further cooled in a cooling tower before being returned to the condenser.

This cycle repeats continuously, providing a stable flow of electricity.

### Function of Turbine Bypass System in a Steam Power Plant

A turbine bypass system in a steam power plant is designed to safely control and redirect steam around the turbine when it's not operating at full capacity or needs to be bypassed for maintenance or operational reasons. This system helps maintain safe and stable operation of the plant while avoiding damage to equipment. The turbine in a steam power plant typically operates at high pressures and temperatures to generate electricity, but sometimes it might not be able to handle the full steam load, such as during startup, shutdown, or when the turbine is undergoing maintenance. The bypass system diverts steam away from the turbine and sends it directly to a condenser or other parts of the system. This allows the boiler to continue producing steam without overloading the turbine and helps regulate pressure and temperature within the plant. In essence, the turbine bypass system ensures that the plant can continue to operate, even when the turbine is not in use, and protects the equipment from potential damage due to fluctuations in pressure or steam flow.

### Components of a Turbine Bypass System in a Steam Power Plant

A Turbine Bypass System in a steam power plant consists of several key components that work together to safely divert steam away from the turbine when needed. The main components include the bypass valves, which control the flow of steam, typically designed for high-pressure conditions. The High-Pressure (HP) Turbine Bypass Valve is the most critical, handling steam that would otherwise enter the turbine. There are also associated control valves that regulate the flow based on pressure and temperature readings to ensure safe operation. Other important components include the piping network, which directs the steam from the boiler or other parts of the plant to the condenser or other heat-exchanging equipment, and the pressure relief valves, which ensure that the system doesn't become over-pressurized. Additionally, the bypass system often includes sensors, actuators, and control systems that monitor and adjust the operation in real time, ensuring the plant remains within safe operational limits and maintains stability during startup, shutdown, or transient conditions.

### HP Turbine Bypass Valve

The High-Pressure (HP) Turbine Bypass Valve in a steam power plant plays a critical role in controlling the flow of steam to the turbine, especially during startup, shutdown, or operational adjustments. When the plant is coming online or being taken offline, the HP turbine bypass valve diverts steam from the boiler away from the turbine and directly to the condenser or other parts of the system. This prevents the turbine from being exposed to steam at too high a pressure or temperature before it is ready to operate, ensuring a smooth and safe transition. Additionally, the valve helps manage the pressure and temperature in the system, maintaining stability and avoiding damage to the turbine. The HP turbine bypass valve is essential for protecting the turbine from thermal stress and for allowing the plant to continue operating when the turbine is not fully loaded.

### Importance of Tight Shutoff in HP Turbine Bypass Valves

Tight shutoff in High-Pressure (HP) Turbine Bypass valves is crucial for ensuring the safe and efficient operation of a steam power plant. These valves control the flow of steam to the turbine, and a tight shutoff prevents any steam from bypassing the turbine when it should not be. Without tight shutoff, there could be steam leakage leading to inefficient operation. It also ensures that during startup, shutdown, or maintenance procedures, the steam is accurately routed to the condenser or other components, preventing damage to the turbine. Tight shutoff helps to maintain the integrity of the pressure and temperature in the system, reduces the risk of thermal stress, and enhances the overall reliability and safety of the plant, ensuring that no steam is wasted, and the system operates within its design limits.

A skilled artisan will appreciate that an apparatus performing the disclosed method includes one or more controller(s) (not shown) programmed or otherwise configured to detect valve leakage and take measures accordingly described elsewhere herein. The controller(s) are communicated with the various components such as warning systems of the power-generating station, as will be appreciated by the skilled artisan.

It will be understood by those of skill in the art that numerous and various modifications can be made without departing from the spirit of the present invention. Therefore, it should be clearly understood that the forms of the present invention are illustrative only and are not intended to limit the scope of the present invention.

What is claimed

1. A method for detecting leakage of a valve upstream of a T-junction where an auxiliary line, which fluidly connects the valve and the T-junction, is fluidly connected to a primary line, the method comprising steps of:
passing fluid through the primary line as a primary fluid flow;
measuring a temperature (T1) and a flow rate (W1) of the primary fluid flow upstream of the T-junction;
measuring a temperature (T2) of fluid, if any, passing through the auxiliary line as a leakage flow toward the T-junction;
identifying a mixing zone formed in the auxiliary line at and upstream of the T-junction, where both the fluid of the primary fluid flow and the fluid of the auxiliary fluid flow are present due to fluid dynamics at the T-junction depending on a flow ratio of a flow rate (W2) of the leakage flow to W1;
measuring a temperature (Tx) of fluid present in the mixing zone, where T1<Tx<T2, and when W2=0, Tx=T1; and
determining W2 from a temperature difference (ΔT) between Tx and T1 based on a predetermined relationship between W2 and ΔT in relation to W1.

2. The method according to claim 1, wherein the valve is a high-pressure bypass steam control valve, the auxiliary line is a high-pressure bypass outlet line, the primary line is a cold reheat line downstream of a high-pressure steam turbine, the fluid passing through the primary line is cold reheat steam passing through the cold reheat line, and the fluid passing through the auxiliary line is fluid passing through the high-pressure bypass outlet line.

3. The method according to claim 1, wherein Tx is measured in the mixing zone a a location away from the T-junction by about a distance (Dx) which corresponds to an inner diameter of a pipe of the auxiliary line.

4. The method according to claim 1, wherein the predetermined relationship between W2 and ΔT is approximately a linear function of W2 and ΔT.
